(19) United States
(12) Patent Application Publication
(10) Pub. No.: US 2006/0028066 A1
(43) Pub. Date: Feb. 9, 2006

(54) Tracked travel device

(76) Inventor: Teiji Yamamoto, Kadoma-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/197,580

(22) Filed: Aug. 5, 2005

(30) Foreign Application Priority Data
Aug. 6, 2004 (JP) 2004-230440
Jul. 20, 2005 (JP) 2005-210050

(51) Int. Cl. B62D 55/14

(52) U.S. Cl. 305/139

(57) ABSTRACT

A tracked travel device in which a track configured by attaching track shoes to a plurality of track links linked in endless fashion by link pins is wound on a sprocket wheel, an idler tumbler, track rollers and carrier rollers that are provided on a track frame or in the vicinity of the track frame, and which is capable of reliably reducing the noise caused by impact of the track with the carrier rollers. A plurality of carrier rollers are provided on the track frame with a center distance of adjacent carrier rollers in a range of 1.0 times to 2.0 times a link pitch of adjacent link pins in the track.

### BACKGROUND OF THE INVENTION

1. Field of the Invention

The present invention relates to a tracked travel device that is used as an undercarriage assembly in, for example, a bulldozer or hydraulic excavator, and more particularly, it relates to a tracked travel device having a track that is constituted by track shoes attached to a plurality of track links linked in endless fashion by link pins, and that is wound on a sprocket wheel, an idler tumbler, track rollers and carrier rollers provided on a track frame or in the vicinity of the track frame.

2. Description of the Related Art

In conventional tracked travel devices of this type, a noise composed of an impact noise (acceleration noise) and a ringing noise, etc. is generated during running of the vehicle, and one of the sources of the noise is a phenomenon of impact of the track, from the forward direction or return direction during running, with the carrier rollers that are provided at the top of the track frame to support the track so as to prevent sagging or meandering of the track due to its weight.

As a technique for reducing the noise generated by the impact of the track with the carrier rollers, a configuration has been proposed in, for example, Japanese Patent Application Laid-open No. 2001-187589, in which a plurality of rim segments are mounted on a roller shell of the carrier rollers via a resilient ring. With this configuration, the noise generated when the track impacts with the carrier rollers can be greatly reduced, thanks to the interposition of the resilient ring described above.

However, in the configuration as described above in which the resilient ring is interposed on the carrier rollers, although it is desirable to form the resilient ring with large thickness in order to increase the noise reduction, the thickness of the resilient ring cannot be formed thick enough due to the configuration of the carrier rollers. Consequently, there has been inconvenience that the noise generated by impact of the track with the carrier rollers could not be effectively reduced.

In view of the above circumstances, the present invention provides a tracked travel device capable of reliably reducing the noise caused by the impact of the track with the carrier rollers.

### SUMMARY OF THE INVENTION

In order to achieve the above object, a first aspect of the present invention provides a tracked travel device having a track including track shoes each being attached to each of a plurality of track links linked in endless fashion by link pins, the track being wound on a sprocket wheel, an idler tumbler, track rollers and carrier rollers provided on a track frame or in vicinity of the track frame, in which the plurality of carrier rollers are provided on the track frame with a center distance of adjacent carrier rollers in a range of 1.0 times to 2.0 times a link pitch of adjacent link pins in the track.

With this construction, by making the center distance of the adjacent carrier rollers provided in the track frame in the range 1.0 times to 2.0 times with respect to the link pitch of adjacent link pins in the track, the bending angle of the track that is supported and guided on the adjacent carrier rollers can be made small and the impact force when the track impacts the carrier rollers can thereby be reduced. This thereby makes it possible to reliably reduce the noise that is generated when the track impacts the carrier rollers.

According to a second aspect of the present invention, in the tracked travel device according to the first aspect of the present invention, the plurality of carrier rollers are provided on the track frame with the center distance of adjacent carrier rollers in a range of 1.2 times to 1.7 times the link pitch of adjacent link pins in the track.

With this construction, by making the center distance of the adjacent carrier rollers provided in the track frame in the range 1.2 times to 1.7 times with respect to the link pitch of adjacent link pins in the track, the bending angle of the track that is supported and guided on the adjacent carrier rollers can be made even smaller and the impact force when the track impacts the carrier rollers can thereby be greatly reduced. This thereby makes it possible to further reliably reduce the noise that is generated when the track impacts the carrier rollers.

According to a third aspect of the present invention, in the tracked travel device according to the first aspect or the second aspect of the present invention, the carrier roller is supported on the track frame via a carrier roller support member and a resilient member is interposed between the track frame and the carrier roller support member.

By this construction, generation of noise due to impact of the track with the carrier rollers is suppressed and, thanks to interposition of the resilient member between the track frame and the carrier roller support member, transmission of the vibration of the carrier rollers to the driver's cab of the vehicle through the track frame can be prevented.

According to a fourth aspect of the present invention, in the tracked travel device according to the first aspect or the second aspect of the present invention, the adjacent carrier rollers are supported on the track frame via a common swinging member swingably supported on the track frame.

By the above construction, noise generation due to impact of the track with the carrier rollers is suppressed and, since the two adjacent carrier rollers can immediately follow movement of the track in the vertical direction since the adjacent carrier rollers are supported on the track frame by means of a common swinging member, the track can be more stably supported and guided by the two carrier rollers.

According to a fifth aspect of the present invention, in the tracked travel device according to the fourth aspect of the present invention, a resilient member is interposed between the track frame and the swinging member.

By the above construction, noise generation due to impact of the track with the carrier rollers is suppressed and, thanks to the interposition of a resilient member between the track frame and the swinging member, the track can be more stably supported and guided by the two carrier rollers and furthermore transmission of the vibration of the respective carrier rollers to the driver's cab of the vehicle through the track frame can be prevented.

According to a sixth aspect of the present invention, in the tracked travel device according to the first aspect or the second aspect of the present invention, a portion of the track that is forward of a central portion in a forward/rearward direction thereof is supported and guided by the adjacent carrier rollers and a portion of the track that is rearward of the central portion in the forward/rearward direction thereof is supported and guided by a single carrier roller separated from the adjacent carrier rollers.

With the above construction, the feed operation of the track from the freely moving rollers and the operation of mounting of the track onto the freely moving rollers are performed smoothly by the adjacent carrier rollers that support and guide the portion of the track that is forward of the central portion in the forward/rearward direction thereof and the feed operation of the track from the sprocket wheel and the operation of mounting of the track onto the sprocket wheel are performed smoothly by the single carrier roller that supports and guides the portion of the track to the rear of the central portion in the forward/rearward direction thereof, so further reduction in the generation of noise when the track impacts the carrier rollers can be achieved.

### BRIEF DESCRIPTION OF THE DRAWINGS

FIG. 1 is a side view of the tracked travel device according to a first embodiment of the present invention;

FIG. 2 is a detail view of the portion H in FIG. 1;

FIG. 3 is a view in the direction of the arrow Q in FIG. 2, shown with a detail broken away;

FIG. 4 is a detail cross-sectional view seen along the line A-A in FIG. 2;

FIG. 5A and FIG. 5B are views showing by way of example the condition of contact of a track link and a carrier roller during circulatory movement of the track;

FIG. 6 is a view showing the bent condition of the track in the case where the substantially central portion in the forward/rearwards direction of the track is supported and guided by a single carrier roller;

FIG. 7 is a graph showing the relationship between the pitch ratio Pr and the bending angle improvement factor Ir;

FIG. 8 is a view showing the bent condition of the track in the case where P1=1.0 P2;

FIG. 9 is a view showing the bent condition of the track in the case where P1 ≈1.7 P2;

FIG. 10 is a view showing the bent condition of the track in the case where P1=2.0 P2;

FIG. 11 is a view showing the bent condition of the track in the case where P1>2.0 P2;

FIG. 12 is a side view of a tracked travel device according to a second embodiment of the present invention;

FIG. 13 is a detail view of the portion H in FIG. 12;

FIG. 14 is a detail cross-sectional view seen along the line A-A in FIG. 13;

FIG. 15 is a side view of a tracked travel device according to a third embodiment of the present invention;

FIG. 16 is a detail view of the portion H in FIG. 15;

FIG. 17 is a detail cross-sectional view seen along the line A-A in FIG. 16;

FIG. 18 is a side view of a tracked travel device according to a fourth embodiment of the present invention;

FIG. 19 is a detail view of the portion H in FIG. 18;

FIG. 20 is a detail cross-sectional view seen along the line A-A in FIG. 19; and

FIG. 21 is a side view of a tracked travel device according to a fifth embodiment of the present invention.

### DETAILED DESCRIPTION OF THE INVENTION

Specific embodiments of the tracked travel device according to the present invention are described below in detail with reference to the drawings.

### First Embodiment

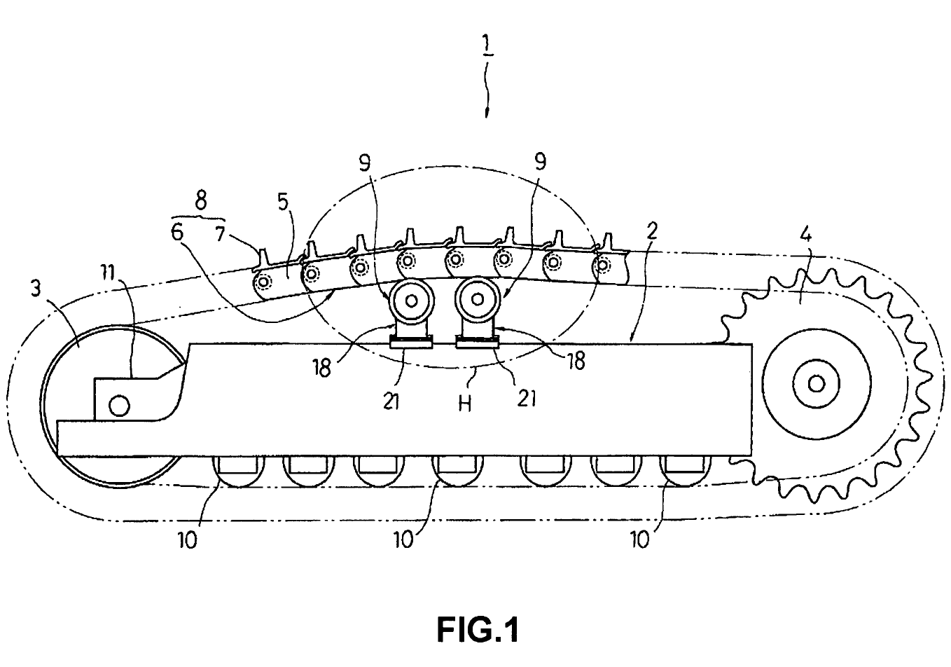

FIG. 1 to FIG. 5A and FIG. 5B show an example of application of the present invention to a tracked travel device of a bulldozer, which is one type of tracked vehicle. The bulldozer (not shown) according to this embodiment is provided with tracked travel devices 1, to be described, on both sides of the vehicle body (not shown) thereof. In the following description, expressions indicating direction such as “forward/rearwards” or “left/right” of course correspond to the forward/rearwards and left/right directions of the bulldozer (vehicle), respectively.

As shown in FIG. 1, a tracked travel device 1 includes a track frame 2 constituting a vehicle undercarriage assembly frame, an idler tumbler 3 arranged on the forward side of this track frame 2 and a sprocket wheel 4 arranged on the rearward side of the track frame 2.

The idler tumbler 3 is mounted at the tip of a yoke 11 to which a prescribed tension is applied in the forward direction by means of a spring, (not shown) and that is mounted so as to be freely moveable in the forward/rearwards direction at the front end of the track frame 2; the sprocket wheel 4 is freely rotatably mounted on a vehicle body (not shown) in the vicinity of the rear end of the track frame 2.

Also, the tracked travel device 1 includes two carrier rollers 9, 9 that support and guide substantially the central portion in the forward/rearward direction of the track 8, to be described, and that are provided at the top of the track frame 2, and a plurality (seven in the case of this embodiment) of track rollers 10, 10 . . . that transmit the vehicle body weight in dispersed fashion to the track 8 and that are provided in rotatable fashion at the bottom of the track frame 2; and also includes the track 8 that circulates on the idler tumbler 3 referred to above, the sprocket wheel 4, carrier rollers 9, 9 and track rollers 10, 10 . . .

The track 8 includes a track chain 6 having a plurality of track links 5, 5 . . . linked in endless fashion and that circulates around the idler 3 and sprocket wheel 4 and track shoes 7, 7 . . . that are secured by means of bolts (not shown) to the ground-engaging face sides of the track links 5, 5 . . . in this track chain 6.

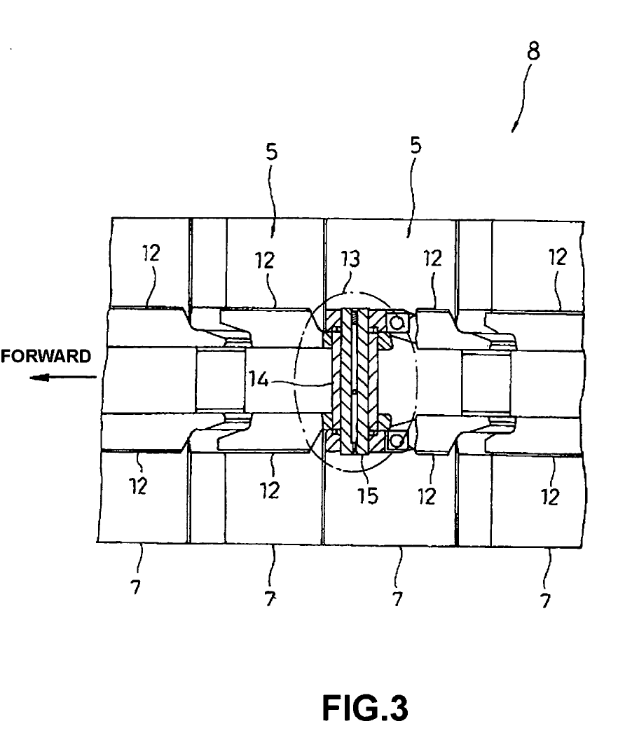

Also, as shown in FIG. 3, the respective track links 5 in the track 8 include a pair of link members 12, 12 that are arranged separated by a prescribed distance in the left/right direction. In a linkage section 13 of adjacent track links 5, 5, link pins 15 that are fixed to the link members 12, 12 of the other track link 5 pass through bushings 14 that are fixed to link members 12, 12 of the one track link 5. The track 8 is made to perform circulatory movement by rotary drive of the sprocket wheel 4 by meshing of the linkage section 13 of the adjacent track links 5, 5 with the between-teeth sections of the sprocket wheel in the sprocket wheel 4.

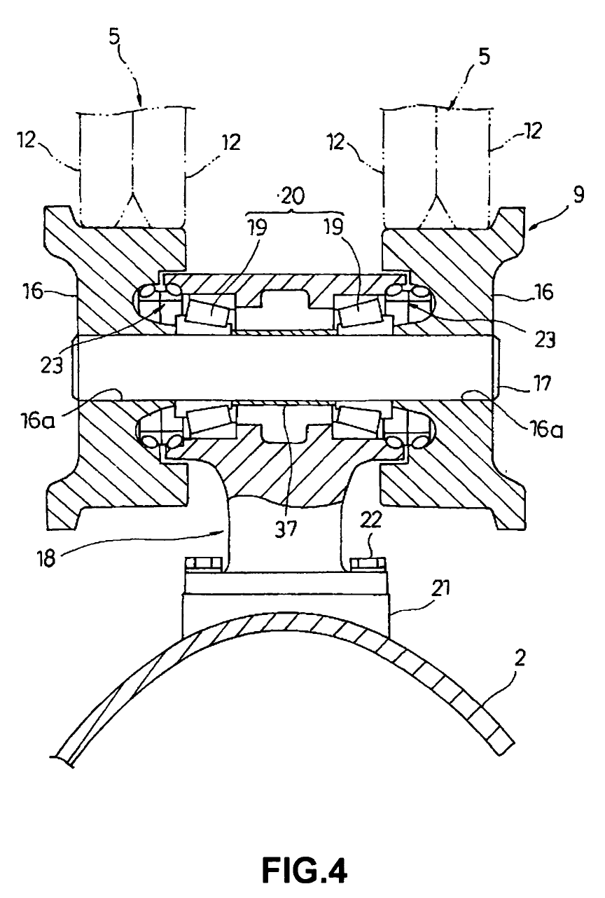

Furthermore, as shown in FIG. 4, the carrier rollers 9 that support and guide the track 8 comprise a pair of roller members 16, 16 arranged separated by a prescribed distance in the left/right direction matching the width dimension of the track links 5, and the pair of roller members 16, 16 arranged on the left and right are unified by mutual coupling through a shaft 17 by force-fitting the ends of the shaft 17 into holes 16a formed in the central portion of the roller members 16.

Also, the carrier rollers 9 are rotatably supported by means of a carrier roller support member 18 mounted on the track frame 2. Specifically, the central section of the shaft 17 linking the pair of roller members 16, 16 is supported at the top end of the carrier roller support member 18 through a bearing device 20 having a pair of tapered roller bearings 19, 19 arranged in the left/right direction and the bottom end of the carrier roller support member 18 is secured using bolts 22 to a mounting seat 21 fixed in the upper surface of the track frame 2. The reference symbol 23 in FIG. 4 is a floating seal that is interposed between the pair of roller members 16, 16 and the bearing device 20 so as to prevent entry of foreign bodies from outside and leakage of oil from the interior and the reference symbol 37 is a collar that supports the pair of roller members 16, 16 with a separation therebetween.

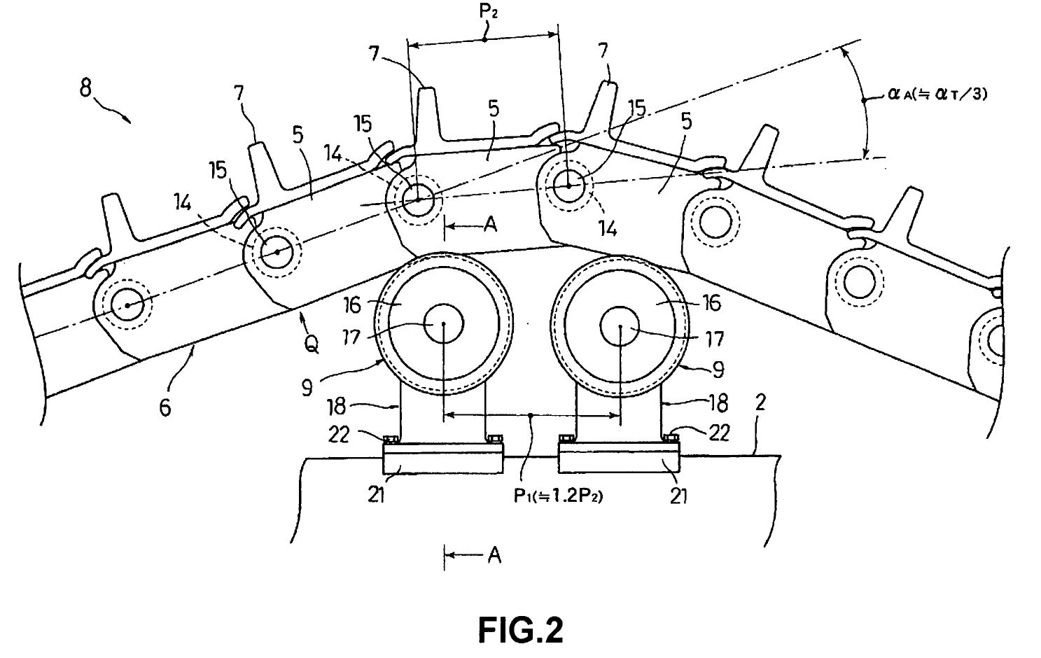

Furthermore, as shown in FIG. 2, the two carrier rollers 9, 9 that are fixed to the upper surface of the track frame 2 are arranged adjacently in the forward/rearward direction of the track frame 2, the arrangement pitch P1 (distance between the adjacent shafts 17, 17 thereof) of these two adjacent carrier rollers 9, 9 being about 1.2 times the linkage pitch P2 (linkage pitch of the adjacent link pins 15, 15) of the track links 5, 5 in the track 8 described above.

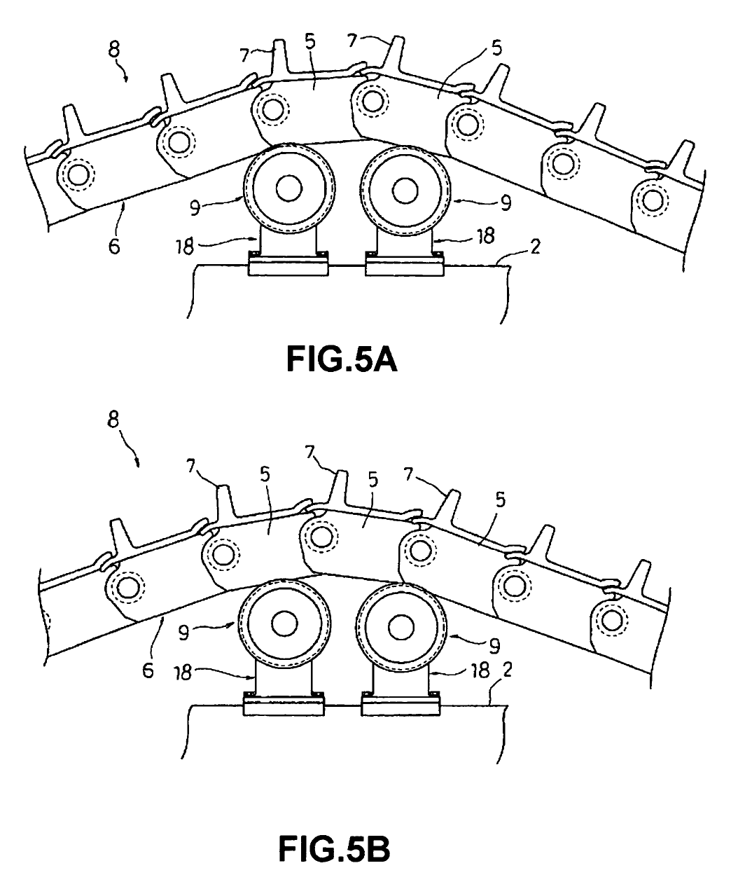

In this way, as shown in FIG. 5A and FIG. 5B, during circulatory movement of the track 8, the two adjacent carrier rollers 9, 9 make contact with two or three successive track links 5 in the track chain 6 of the track 8.

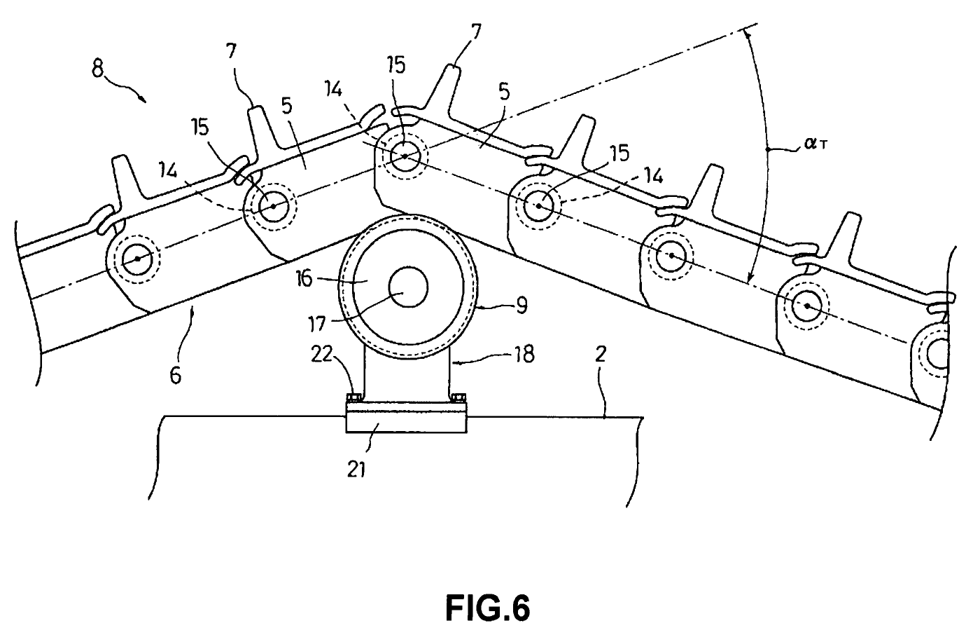

By making the arrangement pitch P1 of the two adjacent carrier rollers 9, 9 in the forward/rearward direction about 1.2 times the linkage pitch P2 of the track links 5, 5 in the track 8 as described above, as shown in FIG. 6, the substantially central portion in the forward/rearward direction of the track 8 can be made to have a bending angle αA as shown in FIG. 2 of the track 8 that is supported by the two carrier rollers 9, 9 of about ⅓ with respect to the bending angle αT of the track 8 in a construction in which supporting and guiding is performed by a single carrier roller 9. The impact force when the track 8 rides up on the carrier rollers 9 is thereby greatly reduced and the noise that is generated caused by the impact of the carrier rollers 9 with the track 8 can thereby be very considerably reduced.

The “bending angle” of the track 8 indicates “the maximum angle that can be created by a plane including the pitch point (center point of the link pins 15) of a track link 5 supported by a carrier roller 9 and a plane linked with these track links 5 and including the pitch point (center point of the link pin 15) of a track link 5 that is not supported by a carrier roller 9.

Since the track chain 6 in the track 8 has a restricted linking pitch P2, the track links 5, 5 bend only at the pitch point (center point of the link pin 15) and the track chain 6 makes contact with a carrier roller 9 whose position is fixed, while following a locus of polygonal shape.

When the track 8 contacts the carrier rollers 9, repetitive movement therefore takes place from one side (track link 5) of the polygon appearing in the track chain 6 to the other adjacent element (track link 5) and the impact noise produced by the impact of the carrier roller 9 and the track link 5 during this movement is a chief component of the noise generated between the track 8 and the carrier rollers 9.

Also, since, in the impact force of the track link 5 with respect to the carrier rollers 9, the force from the forward/rearward direction of the vehicle accompanying circulatory movement (advance/retreat) of the track 8 is large, the impact force of the track link 5 with the carrier roller 9 becomes smaller as the bending angle of the track 8 described above becomes smaller, so noise generated due to impact noise also becomes smaller.

Consequently, in the first embodiment described above, by making the arrangement pitch P1 of the carrier rollers 9, 9 about 1.2 times the linkage pitch P2 of the track links 5, 5 and making the bending angle αA of the track 8 about ⅓ of the bending angle αT (FIG. 6), the noise generated by impact of the track 8 with the carrier rollers 9 is reduced.

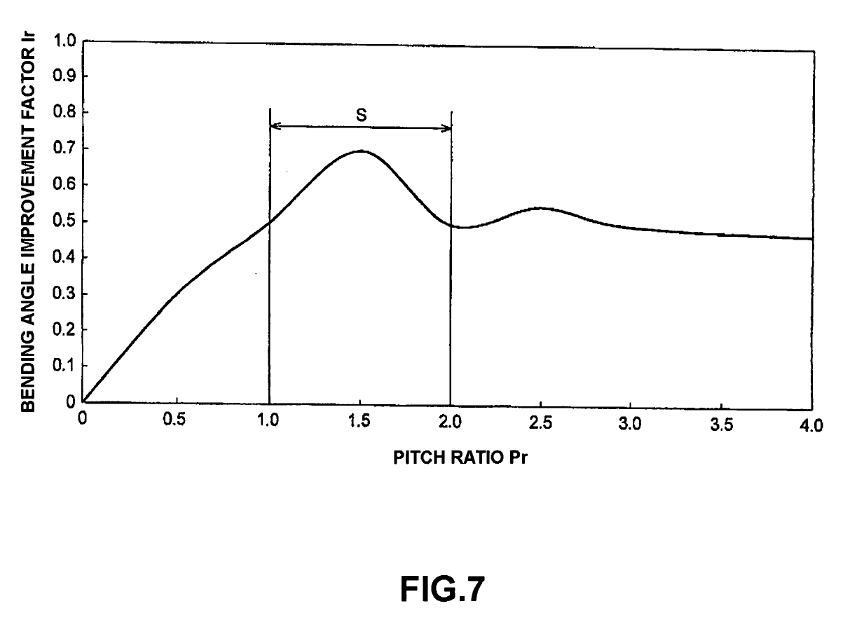

FIG. 7 is a graph showing the relationship between the ratio of the arrangement pitch P1 of the carrier rollers 9, 9 and the linkage pitch P2 of the track links 5, 5 [pitch ratio: Pr=P1/P2] and the ratio of the bending angle αn (αA, αB, αC, αD) with respect to the bending angle αT when the track 8 is supported by a single carrier roller 9, in other words, the ratio of diminution of the bending angle αn with respect to the bending angle αT [bending angle improvement factor: r=1−(αn/αT)].

As is clear from this graph, in the vicinity of a pitch angle Pr 1.5 at which the peak of the bending angle improvement factor Ir (about Ir 0.7) is to be found, the bending angle of the track 8 is smallest, so noise generation caused by impact can be most effectively suppressed.

Also, even in the range S of pitch ratio Pr 1.0 to 2.0 on either side of the peak of the bending angle improvement factor Ir, the bending angle improvement factor Ir is at least 0.5, so the bending angle of the track 8 is small; as a result, noise generation due to impact can be effectively suppressed.

Consequently, although, in the first embodiment, the relationship of the arrangement pitch P1 of two adjacent carrier rollers 9, 9 and the linkage pitch P2 of the track links 5 is specified as P1≈1.2 P2, the arrangement pitch P1 of two adjacent carrier rollers 9, 9 can be freely set in a range of 1.0 times to 2.0 times the linkage pitch P2 of the track links 5.

Furthermore, preferably the arrangement pitch P1 of two adjacent carrier rollers 9, 9 is set in a narrower range on either side of the vicinity of the pitch ratio Pr 1.5 at which the peak of the bending angle improvement factor Ir is to be found, specifically in a range of 1.2 times to 1.7 times the linkage pitch P2 of the track links 5.

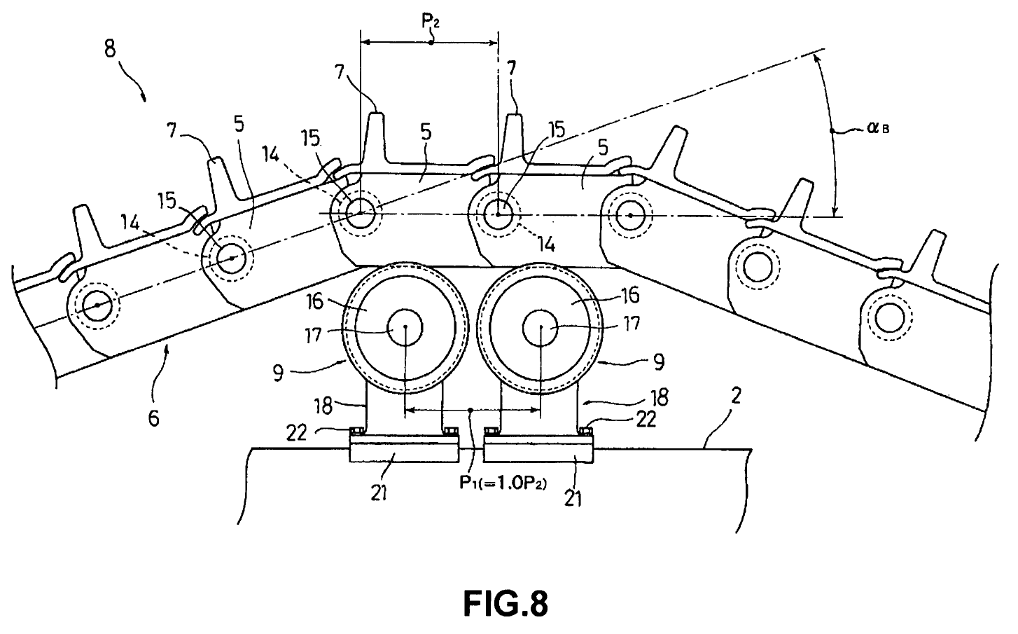

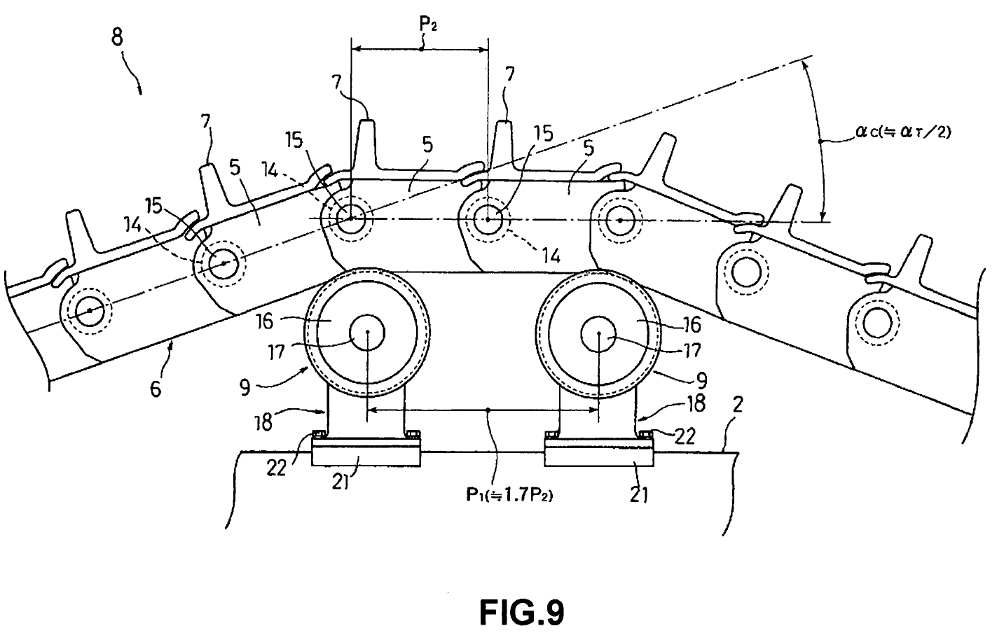

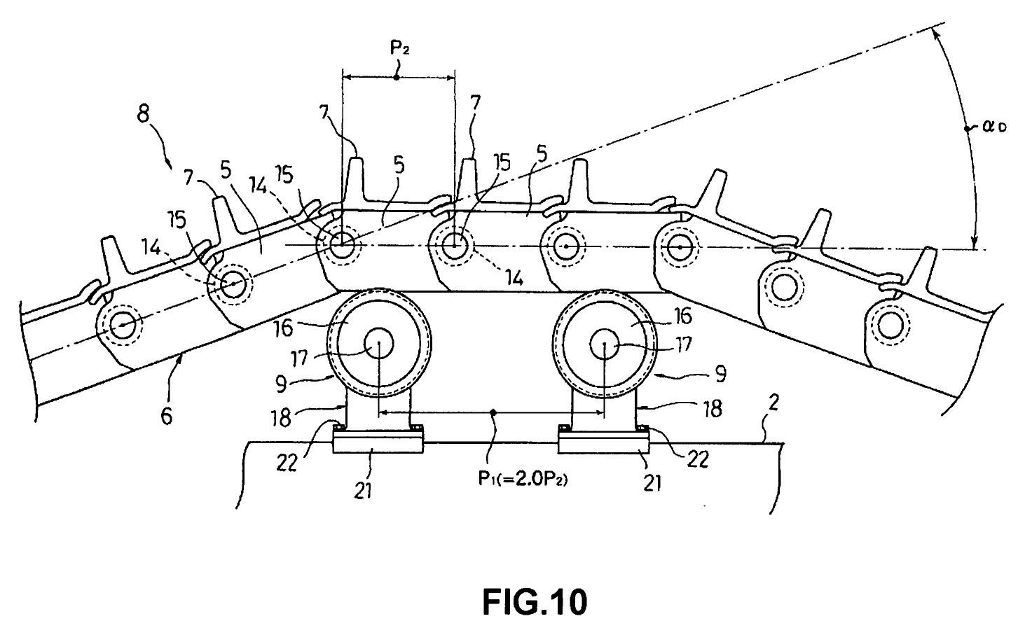

Hereinbelow the positional relationship of the carrier rollers 9 and track 8 at various pitch ratios Pr is specifically described with reference to FIG. 6 and FIG. 8 to FIG. 11. FIG. 7 shows the bent condition of the track 8 in the case where P1=1.0 P2; FIG. 8 shows the bent condition of the track 8 in the case where P1≈1.7 P2; FIG. 9 shows the bent condition of the track 8 in the case where P1=2.0 P2; and FIG. 10 shows the bent condition of the track 8 in the case of P1>2.0 P2, respectively.

(For the case where P1=1.0 P2, see FIG. 6 and FIG. 8).

As can be seen from a comparison of FIG. 6 and FIG. 8, in the case where the arrangement pitch P1 of the two adjacent carrier rollers 9, 9 is 1.0 times the linkage pitch P2 of the track links 5, the bending angle αB of the track 8 that is supported and guided by the adjacent carrier rollers 9, 9 is smaller than the bending angle αT of the track 8 when the track 8 is supported and guided by a single carrier roller 9: generation of noise when the track 8 impacts the carrier rollers 9 can therefore be reduced.

(For the case where P1≈1.7 P2, see FIG. 6 and FIG. 9).

As can be seen from a comparison of FIG. 6 and FIG. 9, in the case where the arrangement pitch P1 of the two adjacent carrier rollers 9, 9 is about 1.7 times the linkage pitch P2 of the track links 5, the bending angle αC of the track 8 that is supported and guided by the two adjacent carrier rollers 9, 9 is about ½ the bending angle αT of the track 8 when the track 8 is supported and guided by a single carrier roller 9: generation of noise when the track 8 impacts the carrier rollers 9 can therefore be reduced.

(For the case where P1=2.0 P2, see FIG. 6 and FIG. 10).

As can be seen from a comparison of FIG. 6 and FIG. 10, in the case where the arrangement pitch P1 of the two adjacent carrier rollers 9, 9 is 2.0 times the linkage pitch P2 of the track links 5, the bending angle αD of the track 8 that is supported and guided by the two adjacent carrier rollers 9, 9 is smaller than the bending angle αT of the track 8 when the track 8 is supported and guided by a single carrier roller 9: generation of noise when the track 8 impacts the carrier rollers 9 can therefore be reduced.

(For the case where P1<1.0 P2, see FIG. 8).

If the arrangement pitch P1 of the two adjacent carrier rollers 9, 9 is less than 1.0 times the linkage pitch P2 of the track links 5, there is a risk of mutual interference of the carrier rollers 9, 9 by further approach of the two adjacent carrier rollers 9, 9 from the condition shown in FIG. 8. It is therefore undesirable that the arrangement pitch P1 of the two adjacent carrier rollers 9, 9 should be less than 1.0 times the linkage pitch P2 of the track links 5.

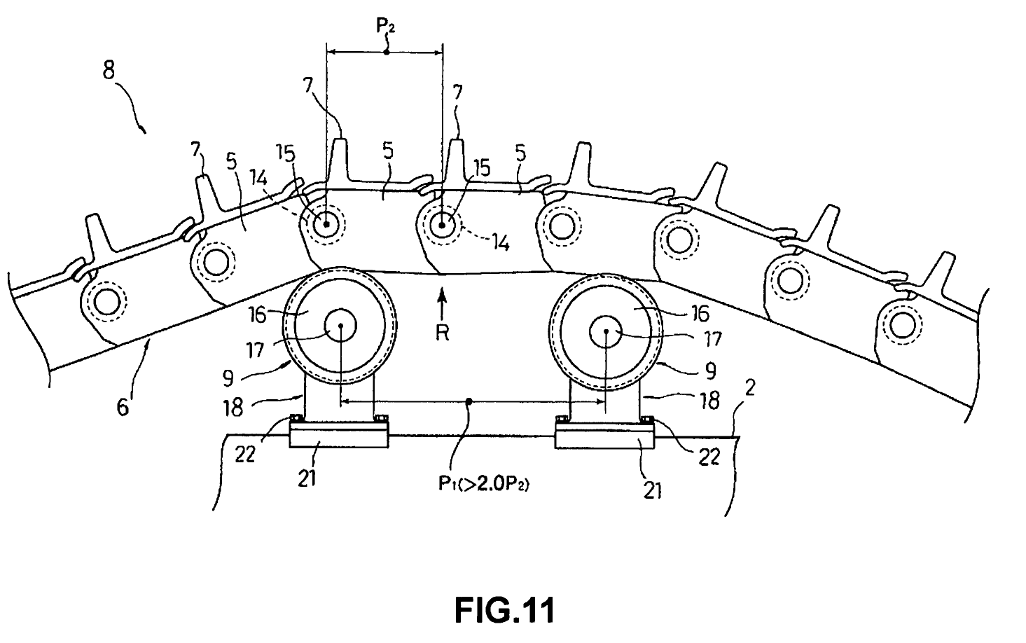

(For the case where P1>2.0 P2, see FIG. 11).

If the arrangement pitch P1 of the two adjacent carrier rollers 9, 9 exceeds 2.0 times the linkage pitch P2 of the track links 5, the track 8 between the two adjacent carrier rollers 9, 9 sags somewhat downwards, so there is a risk of generation of impact noise when the track 8 in this portion (portion indicated by the symbol R in FIG. 11) rides over the carrier rollers 9. It is therefore undesirable that the arrangement pitch P1 of the two adjacent carrier rollers 9, 9 should exceed 2.0 times the linkage pitch P2 of the track links 5.

Also, if the arrangement pitch P1 of the two adjacent carrier rollers 9, 9 greatly exceeds 2.0 times the linkage pitch P2 of the track links 5, for example if the arrangement pitch P1 is about 4.5 times the linkage pitch P2, the track 8 sags considerably downwards between the two adjacent carrier rollers 9, 9, resulting in generation of impact noise when the track 8 in this portion rides over the carrier rollers 9. Furthermore, depending on the degree of slackness of the track 8 and the speed of circulation of the track 8, there is a risk of abnormal vibration of the track 8 being generated due to occurrence of the ringing phenomenon, so it is undesirable that the arrangement pitch P1 of the two adjacent carrier rollers 9, 9 should greatly exceed 2.0 times the linkage pitch P2 of the track links 5.

The arrangement pitch P1 of the two adjacent carrier rollers 9, 9 may therefore be freely set in a range of 1.0 times to 2.0 times the linkage pitch P2 of the track links 5. Also, taking into account wear of the bushings 14 or pins 15 and roller members 16 and other items with increase in time of operation, it may be the to be even more preferable to set the arrangement pitch P1 of the two adjacent carrier rollers 9, 9 in the range 1.2 times to 1.7 times the linkage pitch P2 of the track links 5.

With a tracked travel device 1 constructed as described above, by setting the arrangement pitch (center distance) P1 of adjacent carrier rollers 9, 9 arranged on the track frame 2 in the range 1.0 times to 2.0 times the linkage pitch (link pitch) P2 of adjacent link pins 15, 15 in the track 8, the bending angle of the track 8 that is supported and guided by the adjacent carrier rollers 9, 9 can be made small and the impact force when the track 8 impacts the carrier rollers 9 can thereby be reduced, thus making it possible to very considerably reduce the noise that is generated on impact of the track 8 with the carrier rollers 9.

Also, with a tracked travel device 1 constructed as described above, by setting the arrangement pitch (center distance) P1 of adjacent carrier rollers 9, 9 arranged on the track frame 2 in the range 1.2 times to 1.7 times the linkage pitch (link pitch) P2 of adjacent link pins 15, 15 in the track 8, the bending angle of the track 8 that is supported and guided by the adjacent carrier rollers 9, 9 can be made even smaller and the impact force when the track 8 impacts the carrier rollers 9 can thereby be greatly reduced, thus making it possible to even further considerably reduce the noise that is generated on impact of the track 8 with the carrier rollers 9.

### Second Embodiment

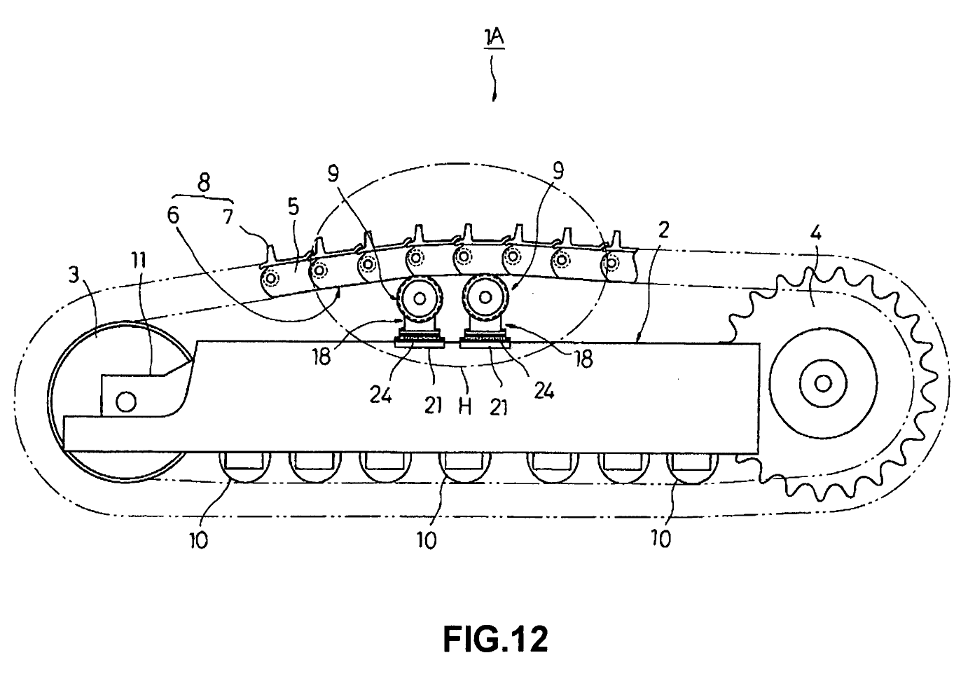

FIG. 12 to FIG. 14 illustrate a second embodiment of a tracked travel device according to the present invention. In this second embodiment, elements that are identical with or similar to those of the first embodiment described above are given the same reference symbols in the Figures and further detailed description thereof is dispensed with: the following description will be focused on the points of difference with regard to the first embodiment.

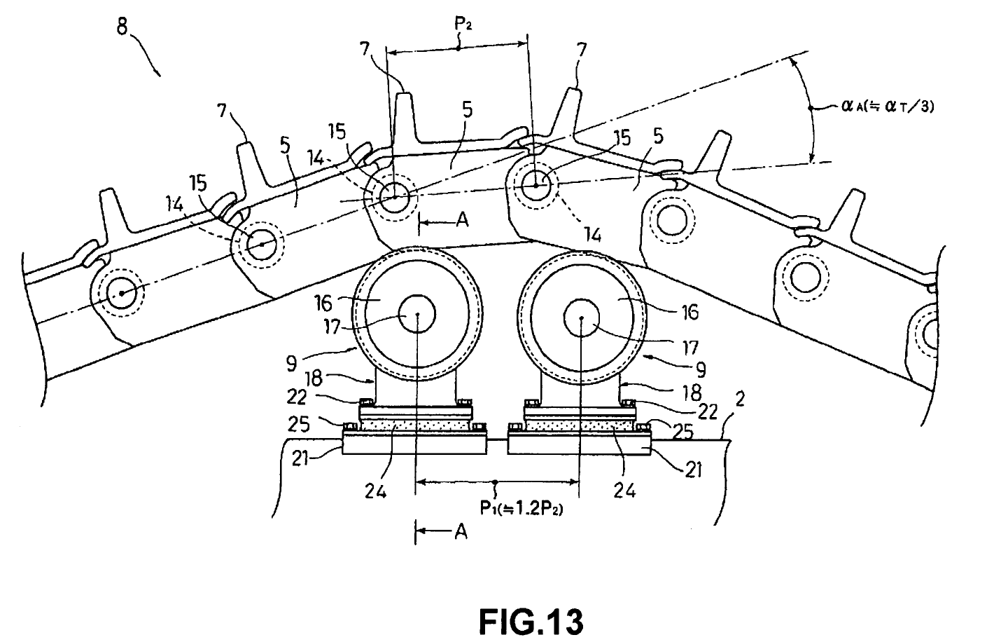

As shown in FIG. 12 and FIG. 13, in the tracked travel device 1A in this embodiment, carrier roller support members 18, 18 as described in the first embodiment are mounted on a track frame 2 by means of respective resilient members 24, 24.

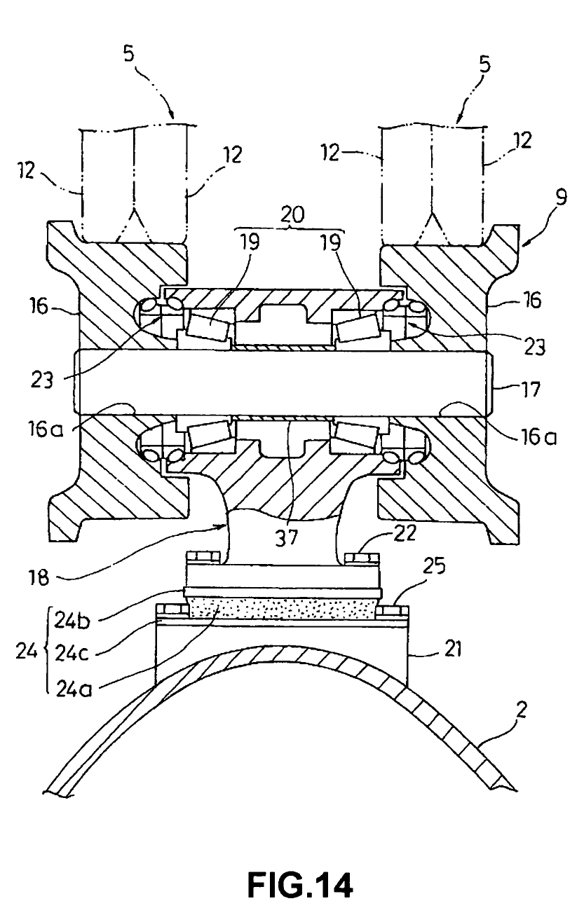

As shown in FIG. 14, a resilient member 24 as described above includes plate-shaped resilient material 24a made for example of rubber or synthetic resin, an upper mounting plate 24b having an upper surface engaging with the undersurface of the bottom end of a carrier roller support member 18, and a lower mounting plate 24c having an undersurface engaging with the upper surface of a mounting seat 21; the undersurface of the upper mounting plate 24b is fixed to the upper surface of the resilient material 24a and the upper surface of the lower mounting plate 24c is fixed to the undersurface of the resilient material 24a.

In addition, the bottom end of the carrier roller support member 18 is secured by means of bolts 22 to an upper mounting plate 24b on the resilient member 24 and the lower mounting plate 24c on the resilient member 24 is secured by means of bolts 25 to the mounting seat 21.

With this embodiment, thanks to the interposition of respective resilient members 24, 24 between the carrier roller support members 18, 18 and track frame 2, vibration of the carrier rollers 9 can be prevented from being transmitted to the driver's cab (not shown) through the track frame 2.

### Third Embodiment

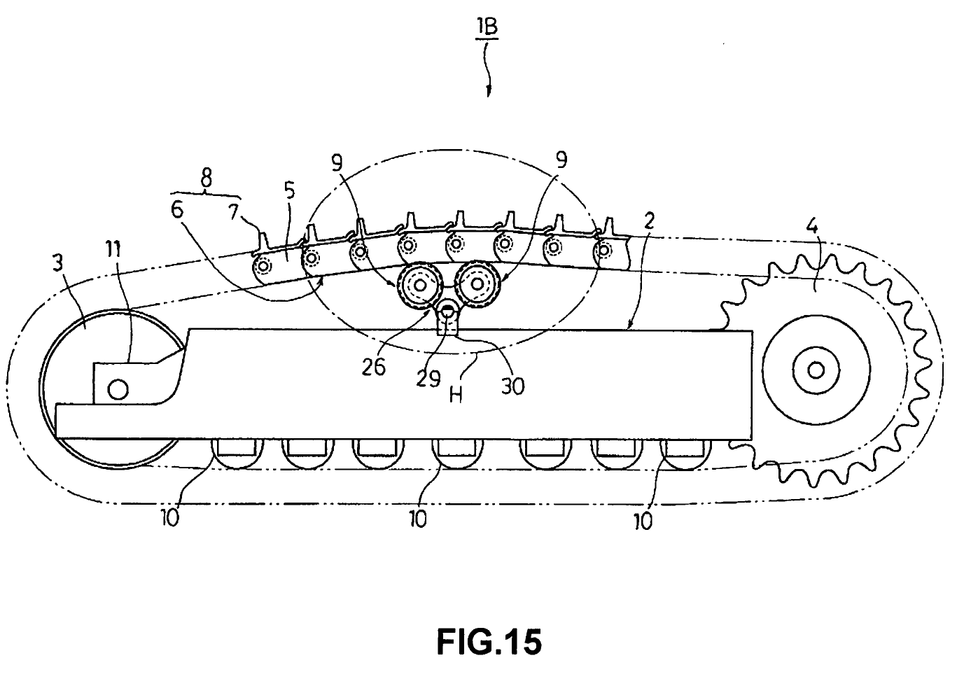

FIG. 15 to FIG. 17 show a third embodiment of a tracked travel device according to the present invention. In this third embodiment, elements that are identical with or similar to those of the embodiments described above are given the same reference symbols in the Figures and further detailed description thereof is dispensed with: the following description will be focused on the points of difference with regard to these embodiments.

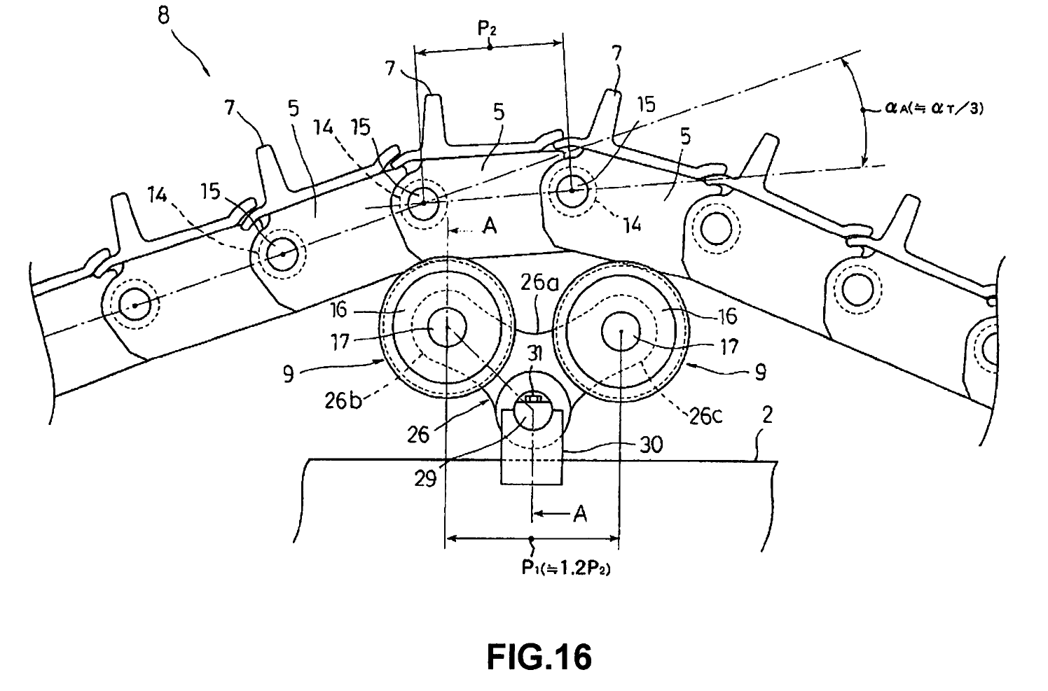

As shown in FIG. 15 in FIG. 16, in the tracked travel device 1B of this embodiment, two adjacent carrier rollers 9, 9 are supported on a swinging member 26 that is mounted on the track frame 2.

As shown in FIG. 16, the swinging member 26 presents a substantially V shape in side view and includes a central section 26a that is rotatably supported on the track frame 2, a front end 26b that rotatably supports the front carrier roller 9 and a rear end 26c that rotatably supports the rear carrier roller 9.

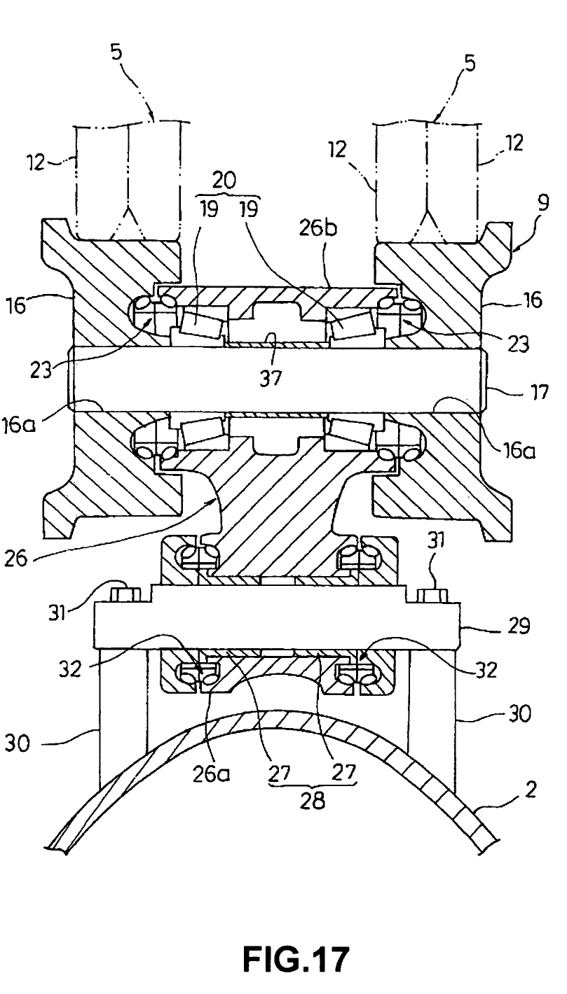

As shown in FIG. 17, the central section 26a of the swinging member 26 is supported on a shaft 29 by means of a bearing device 28 having a pair of flanged bushings 27 arranged in the left/right direction; both ends of this shaft 29 are fixed by securing respective bolts 31 to a pair of shaft support members 30, 30 fixed separated by a prescribed distance in the left/right direction on the upper surface of the track frame 2. Floating seals 32, 32 are mounted at both ends in the left/right direction in the central section 26a of the swinging member 26.

The positions (vertical positions) of the front and rear carrier rollers 9, 9 supported by the swinging member 26 are defined by the movement of the track 8 in the vertical direction. Specifically, when the front carrier roller 9 is pressed down by the track 8, the rear carrier roller 9 pushes up the track 8 and, contrariwise, when the rear carrier roller 9 is pushed down by the track 8, the front carrier roller 9 operates so as to push up the track 8.

With this embodiment, since the two adjacent carrier rollers 9, 9 can immediately follow movement of the track 8 in the vertical direction, the track 8 can be more stably supported and guided by the two carrier rollers 9, 9.

### Fourth Embodiment

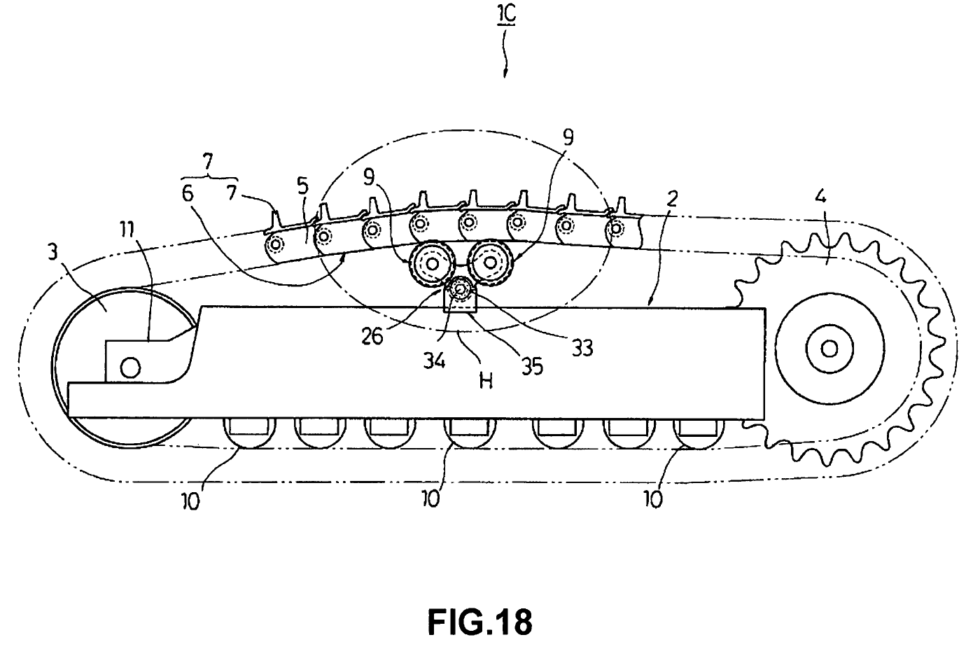

FIG. 18 to FIG. 20 show a fourth embodiment of a tracked travel device according to the present invention. In this fourth embodiment, elements that are identical with or similar to those of the embodiments described above are given the same reference symbols in the Figures and further detailed description thereof is dispensed with: the following description will be focused on the points of difference with regard to these embodiments.

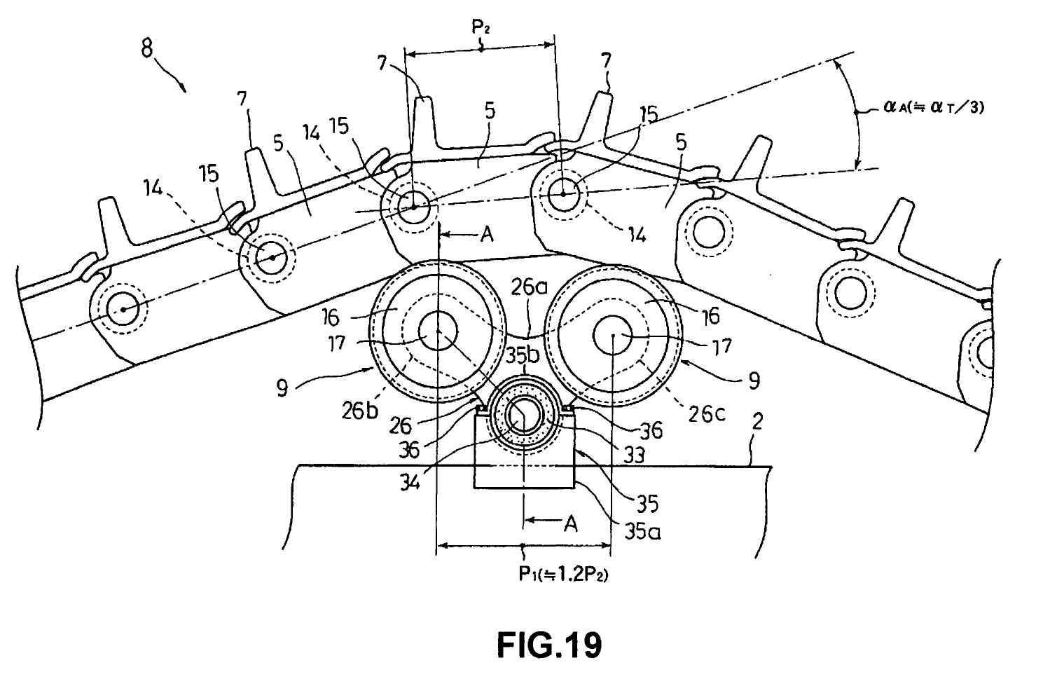

As shown in FIG. 18 in FIG. 19, in a tracked travel device 1C in this embodiment, the swinging member 26 in the third embodiment described above is mounted on a track frame 2 by means of a resilient member 33.

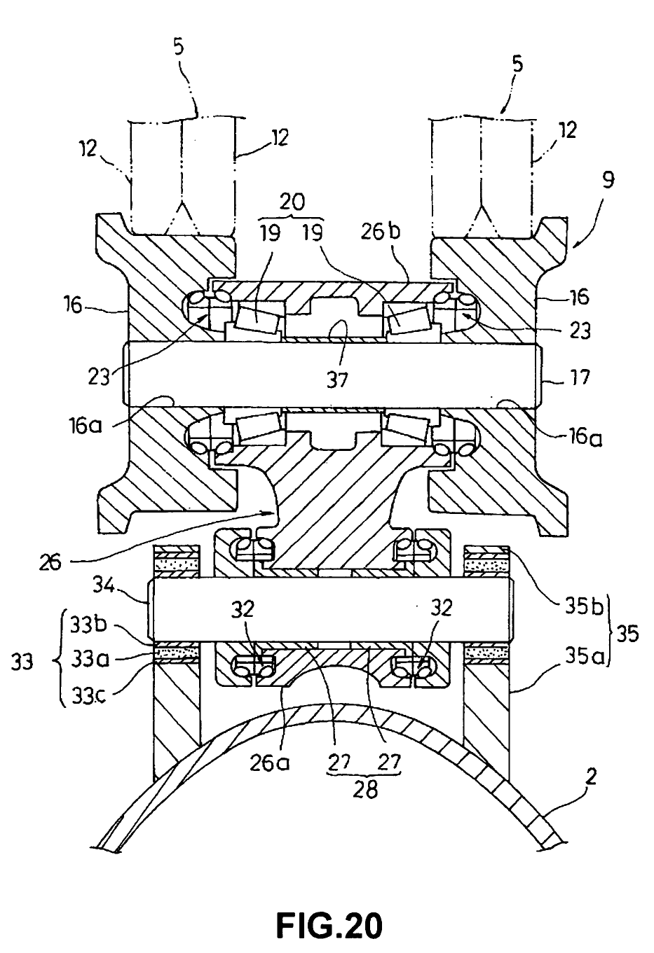

As shown in FIG. 20, the resilient member 33 includes cylinder shaped resilient material 33a made of for example rubber or synthetic resin, an inside cylinder member 33b wherein the ends of the shaft 34 that rotatably supports the central section 26a of the swinging member 26 are force-fitted, and an outside cylindrical member 33c that is arranged outside the resilient member 33a; the outer peripheral surface of the inside cylindrical member 33b is fixed on the inner peripheral surface of the resilient material 33a and the inner peripheral surface of the outside cylindrical member 33c is fixed to the outer peripheral surface of the resilient member 33a.

A divided shaft support member 35 that supports the ends of the shaft 34 by means of a resilient member 33 is fixed to the upper surface of the track frame 2; as shown in FIG. 19 and FIG. 20, this divided shaft support member 35 includes a bed 35a that is fixed to the upper surface of the track frame 2 and a cap 35b that is arranged above this bed 35a and is arranged to be fixed by clamping a resilient member 33 arranged between the bed 35a and the cap 35b by tightening bolts 36.

With this embodiment, since the two adjacent carrier rollers 9, 9 can immediately follow movement of the track 8 in the vertical direction, the track 8 can be more stably supported and guided by the two carrier rollers 9, 9 and furthermore transmission of the vibration of the respective carrier rollers 9, 9 to the driver's cab of the vehicle (not shown) through the track frame 2 can be prevented thanks to the resilient member 33 interposed between the swinging member 26 and the track frame 2.

### Fifth Embodiment

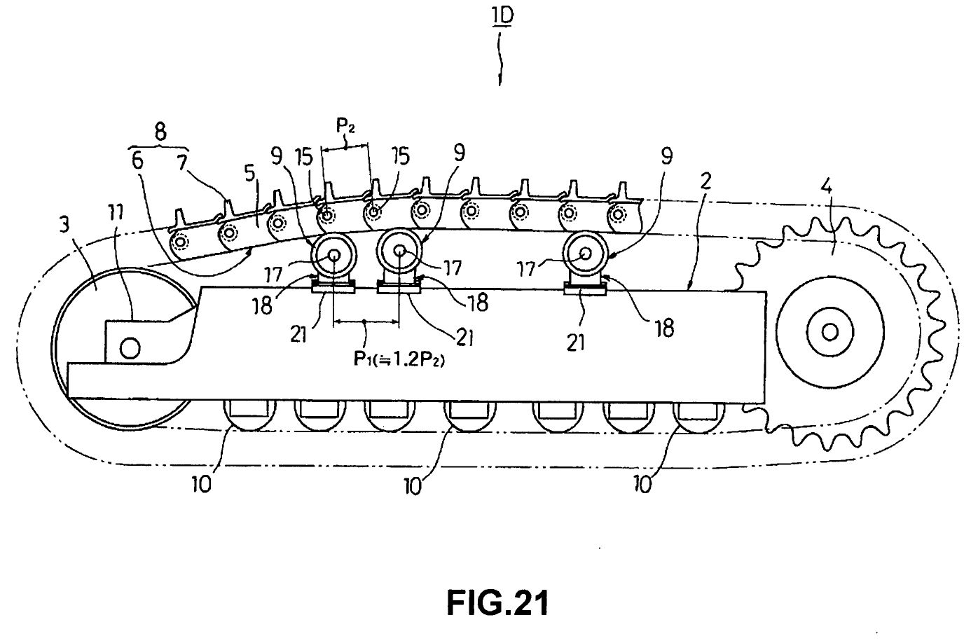

FIG. 21 shows a fifth embodiment of a tracked travel device according to the present invention. In this fifth embodiment, elements that are identical with or similar to those of the embodiments described above are given the same reference symbols in the Figures and further detailed description thereof is dispensed with: the following description will be focused on the points of difference with regard to these embodiments.

In this embodiment, two adjacent carrier rollers 9, 9 are arranged in positions that provides support and guidance somewhat in front of the central section in the forward/rearwards direction of the track 8 and a single carrier roller 9 separate from the aforementioned two adjacent carrier rollers 9, 9 is provided in a position that provides support and guidance somewhat to the rear of the central portion in the forward/rearward direction of the track 8, these three carrier rollers 9, 9, 9 being mounted at the upper surface of the track frame 2 by means of respective carrier roller support members 18 and mounting seats 21.

With this embodiment, thanks to the two carrier rollers 9, 9 that provide support and guidance somewhat in front of the central section in the forward/reverse direction of the track 8, the operation of feeding of the track 8 from the idler tumbler 3 and the operation of winding the track 8 onto the idler tumbler 3 are respectively more smoothly performed and, thanks to the single carrier roller 9 that provides support and guidance somewhat to the rear of the central section in the forward/rearward direction of the track 8, the operation of feeding of the track 8 from the sprocket wheel 4 and the operation of winding the track 8 onto the sprocket wheel 4 are respectively more smoothly performed; generation of noise on impact of the track 8 with the carrier rollers 9 can thereby be further reduced.

This fifth embodiment described above may be put into practice in accordance with the following modes (A), (B), (C) conforming to the gist of the fifth embodiment, although not illustrated in the drawings.

(A) Mode in which the carrier roller support members 18 in the above fifth embodiment are mounted on the track frame 2 by means of a resilient member 24 (see the second embodiment).

(B) Mode in which the two adjacent carrier rollers 9, 9 in the fifth embodiment are supported by means of a swinging member 26 (see the third embodiment).

(C) Mode in which the swinging member 26 according to mode (B) is mounted on the track frame 2 by means of a resilient member 33 (see the fourth embodiment).

In the modes (A), (B), (C) described above, in addition to the beneficial effect of the fifth embodiment, beneficial effects as described hereinbelow under (1) to (3) are obtained.

(1) Thanks to the interposition of a resilient member 24 between the carrier roller support members 18 and the track frame 2 in accordance with Mode (A), the vibration of the carrier rollers 9 can be prevented from being transmitted to the driver's cab (not shown) through the track frame 2.

(2) Since, in accordance with the mode (B), the two adjacent carrier rollers 9, 9 can immediately follow the movement of the track 8 in the vertical direction, the track 8 can be more stably supported and guided by the carrier rollers 9, 9.

(3) In accordance with the mode (C), the two adjacent carrier rollers 9, 9 can immediately follow the movement of the track 8 in the vertical direction so the track 8 can be more stably supported and guided by the carrier rollers 9, 9 and also the vibration of the two adjacent carrier rollers 9, 9 can be prevented from being transmitted to the driver's cab (not shown) through the track frame 2, thanks to the interposition of the resilient member 33.

It should be noted that, although, in the first to the fifth embodiment according to the present invention described above, a track chain of oval shape in side view was described, the present invention is not restricted to this and the present invention could easily be effectively applied also to a track chain of substantially triangular shape in side view.

Also, although, in the first to the fifth embodiment according to the present invention described above, a tracked travel device of a bulldozer was described as one example of a tracked vehicle, the present invention could of course easily be effectively applied also to a tracked travel device of various other types of vehicle apart from bulldozers.

The disclosure of Japanese Patent Application No. 2005-210050 filed on Jul. 20, 2005 including specification, claims and drawings is incorporated herein by reference in its entirety.

What is claimed is:

1. A tracked travel device comprising a track having track shoes each being attached to each of a plurality of track links linked in endless fashion by link pins, the track being wound on a sprocket wheel, an idler tumbler, track rollers and carrier rollers provided on a track frame or in vicinity of the track frame,
wherein a plurality of carrier rollers are provided on the track frame with an center distance of adjacent carrier rollers in a range of 1.0 times to 2.0 times a link pitch of adjacent link pins in the track.

2. The tracked travel device according to claim 1 wherein the plurality of carrier rollers are provided on the track frame with the center distance of adjacent carrier rollers in a range of 1.2 times to 1.7 times the link pitch of adjacent link pins in the track.

3. The tracked travel device according to claim 1 wherein the carrier roller is supported on the track frame via a carrier roller support member and a resilient member is interposed between the track frame and the carrier roller support member.

4. The tracked travel device according to claim 2 wherein the carrier roller is supported on the track frame via a carrier roller support member and a resilient member is interposed between the track frame and the carrier roller support member.

5. The tracked travel device according to claim 1 wherein the adjacent carrier rollers are supported on the track frame via a common swinging member swingably supported on the track frame.

6. The tracked travel device according to claim 2 wherein the adjacent carrier rollers are supported on the track frame via a common swinging member swingably supported on the track frame.

7. The tracked travel device according to claim 5 wherein a resilient member is interposed between the track frame and the swinging member.

8. The tracked travel device according to claim 6 wherein a resilient member is interposed between the track frame and the swinging member.

9. The tracked travel device according to claim 1 wherein a portion of the track that is forward of a central portion in a forward/rearward direction thereof is supported and guided by the adjacent carrier rollers and a portion of the track that is rearward of the central portion in the forward/rearward direction thereof is supported and guided by a single carrier roller separated from the adjacent carrier rollers.

10. The tracked travel device according to claim 2 wherein a portion of the track that is forward of a central portion in a forward/rearward direction thereof is supported and guided by the adjacent carrier rollers and a portion of the track that is rearward of the central portion in the forward/rearward direction thereof is supported and guided by a single carrier roller separated from the adjacent carrier rollers.
